(19) United States
(12) Patent Application Publication
(10) Pub. No.: US 2005/0218627 A1
(43) Pub. Date: Oct. 6, 2005

(54) Hitch device

(76) Inventor: Edward Rowland, Etiwanda, CA (US)

Correspondence Address: FISH & RICHARDSON, PC, 12390 EL CAMINO REAL, SAN DIEGO, CA, 92130-2081, US

(21) Appl. No.: 11/086,823

(22) Filed: Mar. 21, 2005

Related U.S. Application Data
(60) Provisional application No. 60/554,895, filed on Mar. 19, 2004.

(51) Int. Cl. B60D 1/00

(52) U.S. Cl. 280/491.1

(57) ABSTRACT

Described herein are improved devices for rotatably-coupled trailer hitch assemblies. A converter device can be used to convert the front arm of a trailer into a configuration that can be rotatably attached to a pivoting hitch member or coupler arm.

### REFERENCE TO PRIORITY DOCUMENT

This application claims priority of co-pending U.S. Provisional Patent Application Ser. No. 60/554,895 entitled “Hitch Device”, filed Mar. 19, 2004. Priority of the filing date of Mar. 19, 2004 is hereby claimed, and the disclosure of the Provisional Patent Application is hereby incorporated by reference in its entirety.

### TECHNICAL FIELD

This disclosure relates to trailers, and more particularly to a device for converting a trailer into a configuration for use with a pivoting hitch.

### BACKGROUND

For towing purposes, users of boats will position the boat atop a boat trailer during transport of the boat. The boat trailer typically includes a main, support section that is sized to support the entire boat. Thus, the support section is typically at least as long as the entire length of the boat. A towing or coupler arm typically extends forwardly from the support section such that the towing arm increases the overall length of the trailer. The towing arm can be attached to a towing vehicle using a hitch. Due to the size requirements of the support section and the towing arm, the boat trailer is usually longer than the boat that it carries. As a result, storing certain sized boats and their trailers in a confined space, such as in the boat owner's garage, can be difficult, if not impossible. This storage constraint often forces some people to buy smaller boats, as they do not have access to storage space that is large enough to contain the large trailer.

On the other hand, many boaters have a near fanatical devotion to their sport and refuse to sacrifice the size of the boat in order to accommodate a small storage space. Consequently, some boaters resort to expensive and time consuming measures in order to store a boat of a desired size. For example, some boaters have been known to enlarge the sizes of their garage spaces in order to create sufficient room to store boats indoors.

Other boaters may purchase specialized boat trailers where the front of the trailer, specifically the front towing arm area, can be adjusted in size to fit within small areas. There currently exist trailers with hinged towing arms that swing out of the way to a stowing position when not in use, so that the towing arm does not increase the overall length of the trailer when the trailer is in storage. Such devices use tubes that are welded or glued to the sides of a trailer front arm. The tubes are aligned with one or more holes on plates positioned on a rotating towing arm. A pin is then inserted into the tubes and the holes of the plates such that the pin acts as an axis of rotation to permit the towing arm to be rotated to the stowing position when not in use. The process of welding the tubes to the towing arm and aligning the tubes with the plates on the trailer arm can be time consuming, which can add to the overall manufacturing cost of the trailer. Consequently, it can be difficult and costly to adapt an elongated arm for use with a pivoting hitch assembly.

In view of the foregoing, there is a need for devices configured to efficiently adapt an elongated arm for use with a pivoting hitch assembly.

### SUMMARY

Disclosed are improved devices for rotatably-coupled trailer hitch assemblies. A converter device can be used to convert the front arm of a trailer into a configuration that can be rotatably attached to a pivoting hitch member or coupler arm. In one aspect, there is described a device for adapting an elongate arm for use with a pivoting hitch assembly. The device comprises a first shaft structures defining a first shaft configured to receive a pivot pin of the pivoting hitch assembly; a second shaft structure defining a second shaft configured to receive a lock pin of the pivoting hitch assembly; and a connecting member connecting the first shaft structure and the second shaft structure. The connecting wall, first shaft structure, and second shaft structure define a space adapted to receive the end of the elongate arm.

In another aspect, there is described a pivoting hitch assembly, comprising: a first elongate arm; an adapter device attached to the first elongate arm, the adapter device comprising a first shaft member connected to a second shaft member, the first shaft member defining a first shaft and the second shaft member defining a second shaft, the adapter device defining a space between the first and second shaft members in which an end of the first elongate arm is positioned; a second elongate arm; at least one plate attached to the second elongate arm, the plate defining a first aperture aligned with the first shaft and a second aperture aligned with the second shaft; and a pivot pin positioned through the first shaft and the first aperture, the pivot pin defining an axis for relative rotational movement between the first and second elongate arms.

The details of one or more embodiments are set forth in the accompanying drawings and the description below. Other features, objects, and advantages will be apparent from the description and drawings, and from the claims.

### DESCRIPTION OF DRAWINGS

FIG. 1 shows a side view of a boat trailer.

FIG. 2 shows a perspective view of a pivoting trailer hitch device.

FIG. 3 shows a perspective view of a coupler arm of the hitch device.

FIG. 4 shows a perspective view of a front arm of the trailer and hitch device.

FIG. 5 shows a schematic plan view of the coupler arm of the hitch device in a storage position and in a towing position.

FIG. 6 shows a perspective view of a converter device for converting an elongate rod into a coupler arm of a pivot hitch system.

FIG. 7 shows a top view of the converter device.

FIG. 8 shows a top view of the converter device prior to being mounted to coupler arm.

FIG. 9 shows a top view of the converter device mounted to a coupler arm.

FIG. 10 shows a top view of another embodiment of a converter device.

Like reference symbols in the various drawings indicate like elements.

### DETAILED DESCRIPTION

Described herein are improved devices for rotatably-coupled trailer hitch assemblies. A converter device can be used to convert the front arm of a trailer into a configuration that can be rotatably attached to a pivoting hitch member or coupler arm.

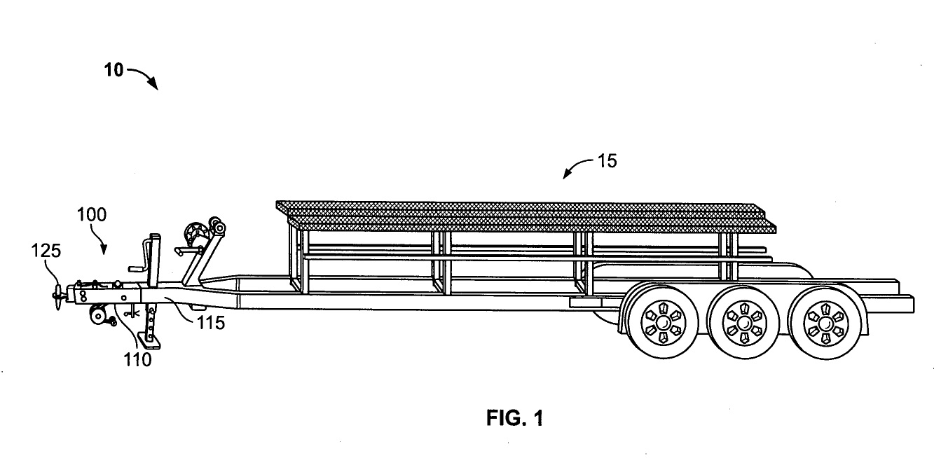

FIG. 1 shows a perspective view of a boat trailer 10 having a support section 15 configured to provide support to a boat in a well-known manner. The boat trailer includes a pivoting hitch device 100 including an elongate tongue or front arm 115 that extends forwardly from a front end of the support section 15 of the trailer 10. The front arm 115 can be integrally attached to the trailer or it can be a separate piece that is welded to the trailer. The front arm 115 is rotatably-attached to an elongate, rotatable hitch or coupler arm 110, as described more fully below. The coupler arm 110 has a front end on which is located a coupler device 125, such as a hitch, that can removably mate with a towing vehicle (not shown) in a well-known manner for towing the trailer 10. In one embodiment, at least a portion of the coupler arm 110 is a brake actuator cover that has an outer member and an inner member. The trailer 10 can include any of a plurality of trailer components, such as wheels, a retractable jack, support members, etc.

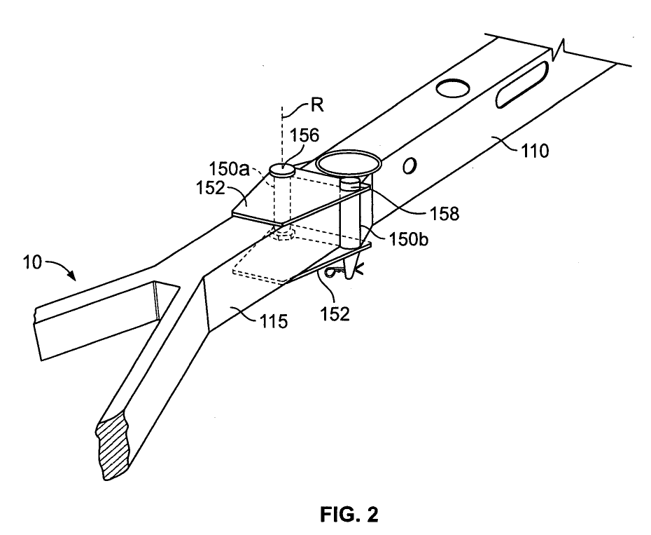

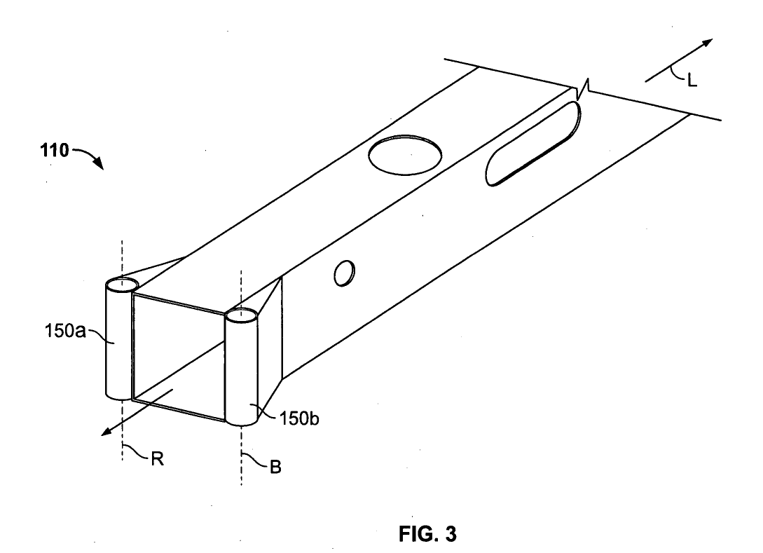

The elongate front arm 115 and coupler arm 110 are pivotably attached to another using a pivoting hitch device, such as in the manner described in U.S. Pat. Nos. 6,364,337 and 5,890,617, which are incorporated herein by reference in their entirety. As shown in FIG. 2, a conventional pivoting hitch device 100 includes two tubes 150a, 150b (collectively referred to as tubes 150) that are attached to opposed sides of the coupler arm 110 in a well known manner. FIG. 3 shows a perspective view of the coupler arm 110 disassembled from the front arm 115. The tubes 150 are attached to opposed sides of the coupler arm 110, such as by using gussets in combination with welds or in any other manner. The tube 150a defines an axis R and the tube 150b defines an axis B.

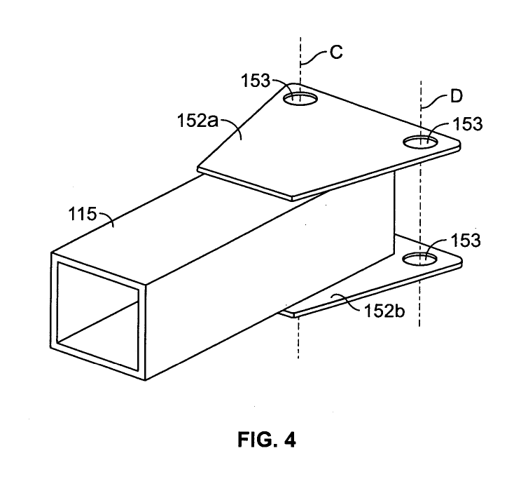

With reference again to FIG. 2, plates 152a and 152b (collectively plates 152) are positioned on opposed top and bottom sides of the front arm 115 of the boat trailer 10. FIG. 4 shows a perspective view of the front arm 115 disassembled from the coupler arm 110. For clarity of illustration, the remainder of the trailer 10 is not shown in FIG. 4. Each plate 152 includes a pair of holes 153. The top plate 152a and the bottom plate 152b are positioned on the top and bottom surfaces of the front arm 115 such that the holes 153 in the top plate 152a align with the holes 153 on the bottom plate along axes C and D. The plates 152 are attached to the front arm 115 in any manner.

With reference to FIGS. 2-4, the coupler arm 110 is attached to the front arm 110 by aligning the plates 152 and the tubes 150 such that the axis C formed by the holes 153 align with the axis R of the tube 150a. Likewise, the axis D formed by the holes 153 is aligned with the axis B of the tube 150b. Thus, each tube 150 is axially aligned with a top hole and a bottom hole of the plates 152.

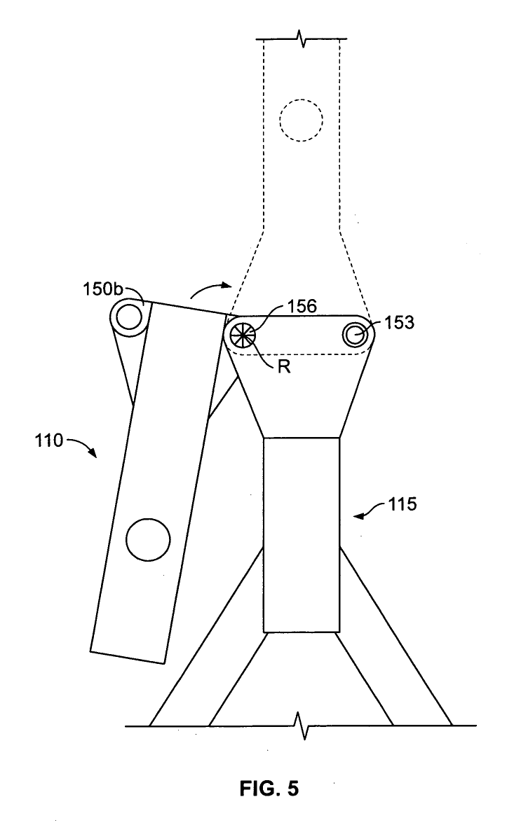

A pivot pin 156 is inserted through the tube 150a such that the pivot pin 156 couples the tube 150a to the plates 152 and thereby couples the coupler arm 110 to the front arm 115. The pivot pin 156 can have flanges or other such structure that retain the pivot pin within the tube 150a and the plates 152. The pivot pin 156 provides an axis of rotation R about which the coupler arm 110 can be rotated relative to the front arm 115 of the trailer 10. When the coupler arm 110 is oriented as shown in FIG. 1, the coupler arm 110 is axially aligned with the front arm 115 and with the longitudinal axis of the trailer 10. The coupler arm is in a “towing orientation” in FIG. 1 in that the coupler arm 110 can be attached to a towing vehicle for towing the trailer The coupler arm 110 can be secured in the towing orientation by removably inserting a lock pin 158 into the tube 150b. The lock pin 158 provides an interfering engagement between the tube 150b and the plates 152 to prevent the coupler arm 110 from being rotated out of the towing orientation. The lock pin 158 can be removed from the tube 150b to permit the coupler arm 110 to be rotated out of the towing orientation and into a storage position wherein the coupler arm 110 is positioned transverse to the longitudinal axis of the trailer 10 and the front arm 115. FIG. 5 shows a schematic plan view of the coupler arm in the storage position and in the towing position. FIG. 5 shows the coupler arm 110 in solid lines in the storage position and in phantom lines in the towing position. As mentioned, the coupler arm is moved to the storage position by removing the lock pin 158 from the tube 150b and rotating the coupler 110 arm about the axis R, which is aligned with the axis of the pivot pin 156.

In this manner, when not in use the coupler arm 110 of the hitch member 100 can be rotated to a stowing position wherein the coupler arm 110 of the hitch member does not increase the overall longitudinal length of the trailer. It should be appreciated that the positions of the tubes and plates could be swapped such that the tubes 150 are on the front arm 115 and the plates 152 are on the coupler arm 110 of the trailer 10.

It should be appreciated that it can be difficult to manufacture a pivoting hitch device 100 of the type described above. There are several steps involved in manufacture, including welding the two tubes to the front arm 115 of the trailer, which can require that one or more gussets be used in order to secure the tubes to the front arm 115. In addition, the tubes have to be properly aligned with the front arm 115 and with the plates on the bottom and top of the hitch member 120. The alignment process can be time consuming, particularly when the axes of the tubes have not been properly oriented. Consequently, this can add to the overall cost of the hitch system and the trailer.

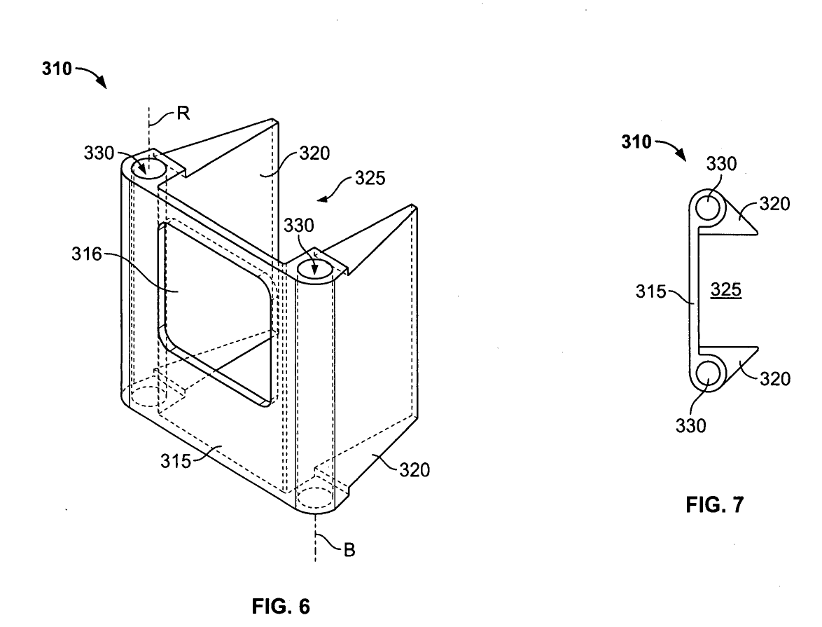

With reference now to FIG. 6, there is shown a converter device 310 that can be used to easily convert an elongate rod or tubing, such as the front end of a trailer or a coupler arm, into a configuration that is suitable for use in a pivoting hitch system of the type described above. The converter device 310 comprises a fitting that is attached to an end of the front arm of a trailer or to a coupler arm. The converter device includes a pair of enclosed shafts that can be easily coupled to the plates 152 of a corresponding arm of the type shown in FIG. 4.

FIG. 6 shows a perspective view of a adapter or converter device 310 and FIG. 7 shows a top view of the converter device 310. When viewed from the top, the converter device 310 is generally u-shaped such that it includes a connector structure, such as a connector wall 315, and a pair of opposed shaft structures 320 disposed on opposed ends of the connector wall 315. The connector wall 315 is substantially planar, although it can vary in shape. The connector wall 315 can optionally have an aperture 316 extending therethrough.

The connector wall 315 and the shaft structures 320 define a space or cavity 325 therebetween, wherein the space 325 has a width W that is substantially equal to or larger than the arm to which the device 310 is coupled. The space 325 has a size and shape that is configured to receive the an elongate member such as the front arm of a boat trailer or a coupler arm that can be attached to the front of a boat trailer. In the illustrated embodiment, the space 325 is rectangular in shape such that it can receive a correspondingly shaped rectangular front arm. However, it should be appreciated that the shape of the space can vary in order to mate with and receive any of a wide variety of shaped members.

With reference still to FIGS. 6 and 7, the shaft structures 320 each comprise a barrel-like structure having an internal, elongate shaft 330 that is sized to receive therein a pin. In the embodiment shown in FIGS. 6 and 7, a portion of the shaft structures 320 are elongated and tapered moving away from the connector wall 315 such that the shaft structures 320 have a triangular shape. It should be appreciated, however, that the shape of the shaft structures 320 can vary. The shafts 330 define axes R and B that correspond to the axes R and B defined by the tubes 150a and 150b (FIG. 3) that are affixed to the coupler arm 110. As described below, the converter device 310 can be affixed to a coupler arm 110 in place of the tubes 150 and thereby provide the coupler arm 110 with shafts through which a pivot pin and a lock pin can be positioned.

The converter device 310 can be attached to the coupler arm 110 to provide the coupler arm 110 with properly positioned shafts that can be aligned with corresponding holes on the plates 152 of the front arm 115 (shown in FIG. 4). The converter device 310 is used in place of the tubes 150 that would otherwise have to be mounted onto the coupler arm 110. The converter device 310 thus provides a quick and efficient means of positioning pin shafts on a coupler arm. Alternately the relative positions can be reversed, with the converter device 310 mounted on the front arm 115 and the plates 152 mounted on the coupler arm 110. For efficiency of description, the converter device is described herein in the context of being attached to the coupler arm 110, although it is appreciated that the converter device 310 can also be attached to the front arm 115 and the plates 152 attached to the coupler arm 110.

The converter device 310 is mounted on the coupler arm 110 as follows. A first end of the coupler arm 110 is inserted into the space 325 formed by the connector wall 315 and the shaft structures 320. As mentioned, the space 325 is sized and shaped to receive the end of the coupler arm 110 therein. The space 325 can be sized and shaped to provide a snug fit with the coupler arm, or it can be sized and shaped to provide any desired clearance between the converter device 310 and the coupler arm 110. After the coupler arm 110 is inserted into the space 325, the coupler arm 110 is secured therein, such as by using a weld or other attachment means such as bolts, screws, glue, etc.

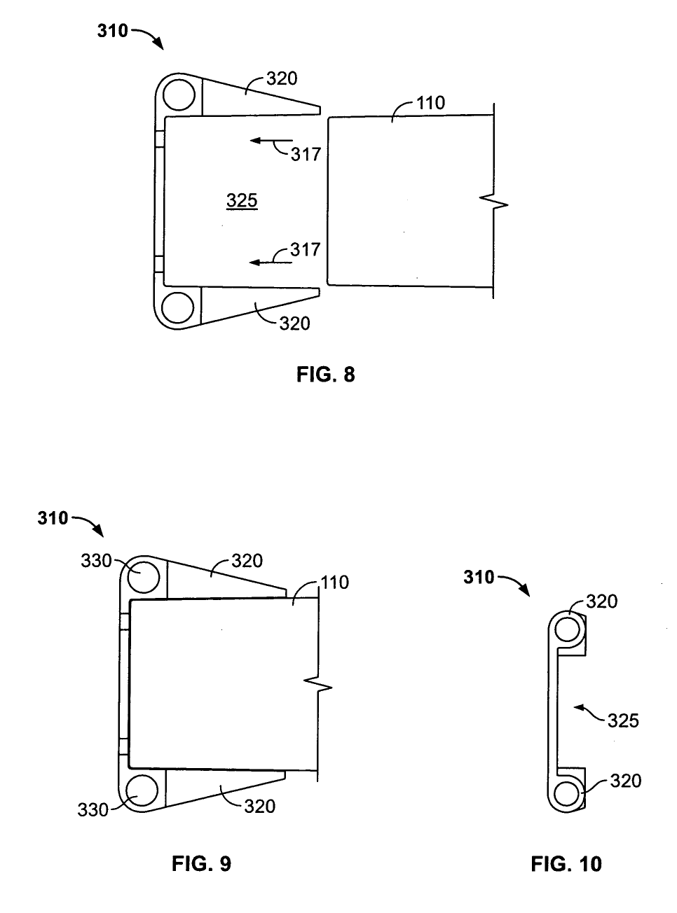

FIG. 8 shows a top view of the converter device 310 with an end of the coupler arm 110 positioned adjacent the space 325. As represented by the arrows 317, the coupler arm 110 is inserted into the space 325 and secured therein so that the converter device 310 is attached to the coupler arm 110. FIG. 9 shows a top view of the coupler arm 110 secured within the space 325 and attached to the converter device 310. As shown, the coupler arm 110 is sandwiched between the shaft structures 320 and a front edge of the coupler arm 110 is adjacent the connector wall 315. The coupler arm 1110 can be fixedly attached to the converter device 310 in a variety of manners, including welds, bolts, glue, etc. As mentioned, the coupler arm 110 does not necessarily fit tightly within the space 325. A spacing can exist between the coupler arm and the internal walls of the converter device 310 that form the space 325.

With converter device 310 attached to the coupler arm 110, the coupler arm 110 is equipped with pin shafts 330, which correspond to the pin shafts that were formerly defined by the tubes 150, such as was shown in FIG. 3. The coupler arm 110 is then coupled to the front arm 115 (as shown in FIG. 2) by aligning each pin shaft 330 with a corresponding pair of holes in the top and bottom plates 152. A pivot pin is inserted into one of the shafts 330 and the holes in the plate to provide an axis of rotation for the coupler arm 110. A lock pin can be inserted into the other shaft to lock the coupler arm in the towing position. As mentioned, the lock pin is removed to permit the coupler arm 110 to be rotated to the storage position, as shown in FIG. 5.

As mentioned, the converter device 310 can be attached to the front arm 115 rather than the coupler arm 110 of the trailer. In such a situation, the plates would be attached to the coupler arm 110.

It should be appreciated that the size and shape of the shaft structures 320 can vary, such as to accommodate coupler arms of different sizes and shapes. For example, FIG. 10 shows an another embodiment of the converter device 310. In this embodiment, the shaft structures 320 are substantially rectangular when viewed from the top and do not taper as in the previous embodiment. The size of the cavity 325 is smaller along a longitudinal direction than in the previous embodiment, although the cavity 325 is sized to receive a portion of the coupler arm 110.

A number of embodiments have been described. Nevertheless, it will be understood that various modifications may be made without departing from the spirit and scope of the claims. Accordingly, other embodiments are within the scope of the following claims.

1. A device for adapting an elongate arm for use with a pivoting hitch assembly, comprising:
a first shaft structures defining a first shaft configured to receive a pivot pin of the pivoting hitch assembly;
a second shaft structure defining a second shaft configured to receive a lock pin of the pivoting hitch assembly;
a connecting member connecting the first shaft structure and the second shaft structure, wherein the connecting wall, first shaft structure, and second shaft structure define a space adapted to receive the end of the elongate arm.

2. The device of claim 1, wherein the elongate arm comprises a coupler arm of the pivoting hitch assembly.

3. The device of claim 1, wherein the elongate arm comprises a front arm of a trailer.

4. The device of claim 1, wherein the space is substantially rectangular.

5. The device of claim 1, wherein the first and second shaft structures a barrel-shaped.

6. The device of claim 1, wherein the first and second shaft structures are elongated and taper in width moving away from the connecting member.

7. The device of claim 1, wherein the connecting member comprises a rectangular wall.

8. The device of claim 1, wherein the space has a width that is slightly larger than a width of the elongate arm.

9. A pivoting hitch assembly, comprising:
a first elongate arm;
an adapter device attached to the first elongate arm, the adapter device comprising a first shaft member connected to a second shaft member, the first shaft member defining a first shaft and the second shaft member defining a second shaft, the adapter device defining a space between the first and second shaft members in which an end of the first elongate arm is positioned;
a second elongate arm;
at least one plate attached to the second elongate arm, the plate defining a first aperture aligned with the first shaft and a second aperture aligned with the second shaft;
a pivot pin positioned through the first shaft and the first aperture, the pivot pin defining an axis for relative rotational movement between the first and second elongate arms.

10. The assembly of claim 9, wherein the first elongate arm comprises a front arm of a trailer and the second elongate arm comprises a coupler arm for coupling the trailer to a towing vehicle, the second elongate arm being rotatable relative to the first elongate arm about the axis.

11. The assembly of claim 9, wherein the second elongate arm comprises a front arm of a trailer and the first elongate arm comprises a coupler arm for coupling the trailer to a towing vehicle, the first elongate arm being rotatable relative to the second elongate arm about the axis.

12. The assembly of claim 9, wherein the adapter device includes a connector wall connecting the first and second shaft members, the first and second shaft members positioned on opposed ends of the connector wall.

13. The assembly of claim 9, wherein the space has a size and shape that correspond to a size and shape of the first elongate arm.

14. The device of claim 9, wherein the first and second shaft structures a barrel-shaped.

15. The device of claim 9, wherein the first and second shaft structures are elongated and taper in width moving away from the connecting member.
